(19) United States
(12) Patent Application Publication
(10) Pub. No.: US 2015/0275845 A1
(43) Pub. Date: Oct. 1, 2015

(54) Flow Power Plant

(71) Applicant: VOITH PATENT GMBH, Heidenheim (DE)

(72) Inventor: Klaus Sommerkorn, Heidenheim (DE)

(73) Assignee: Voith Patent GmbH, Heidenheim (DE)

(21) Appl. No.: 14/437,587

(22) PCT Filed: Jan. 14, 2014
(86) PCT No.: PCT/EP2014/050554

§ 371 Date: Apr. 22, 2015

(30) Foreign Application Priority Data
Jan. 24, 2013 (DE) 10 2013 001 212.0

(51) Int. Cl. F03B 3/12; F03B 17/06

(52) U.S. Cl. CPC F03B 3/128; F03B 17/061

(57) ABSTRACT

There is provided a flow power plant including at least one turbine and a hub with at least one rotor blade, where a plurality of tie rods for applying a pretensioning force are arranged inside or outside of the at least one rotor blade in the region of a connection of the at least one rotor blade to the hub.

The invention relates to a flow power plant according to the preamble of claim 1.

Flow power plants are known. They can be arranged in form of free-standing units with rotor-shaped water turbines for power generation from a watercourse or marine current, especially a tidal current. Such flow power plants can also be arranged as onshore or offshore wind power plants.

Such flow power plants are typically installations that are completely immersed, so that the at least one turbine of the flow power plant is arranged completely under water during its operation. The turbine is carried by a foundation structure. Such foundation structures are usually gravity foundations or foundations made of steel constructions such as tripods, or pillar or post structures. Such foundation structures are usually arranged in the manner of posts towards the turbine. The cross-section of said posts must not necessarily be round, since an oval or linear cross-section can be considered. The present invention relates to such generic flow power plants.

The foundation structure absorbs the forces and the torques which are produced by the flow towards the flow power plant. It conducts said forces and torques into the surrounding ground, e.g. the ground of the water body.

Foundation structures can comprise a supporting pillar for example which is connected to a foundation on the ground of the water body. The supporting pillar is conventionally arranged towards the turbine to taper as much as possible. As a result, an influence on the flow by the tapering cross-section of the supporting pillar which acts as a flow resistance is thus reduced. This also has a positive effect on the efficiency of such a flow power plant. The slender configuration of the supporting pillar in the region of the connection to the turbine comes with the disadvantage however that there is a critical point in the strength, especially in its bottom part. A limit value for the maximum or dynamic load of the material tension of the supporting pillar can often be reached at this point, which corresponds to the maximum value of the expected operational lifespan of the supporting pillar. Consequently, a further reduction in the cross-section of the supporting pillar is technically no longer feasible.

The present invention is therefore based on the object of providing a flow power plant which avoids the disadvantages of the prior art. An especially slender foundation structure is to be provided in particular, in which the tensions occurring during the operation of the flow power plant are reduced.

This object is achieved by a flow power plant with the features according to the independent claims. The dependent claims describe advantageous and especially appropriate embodiments of the invention.

A flow power plant in accordance with the invention comprises at least one turbine and a foundation structure on which the at least one turbine is supported. The foundation structure comprises at least one supporting pillar which is connected to a foundation or a structure at the bottom of the body of water. In accordance with the invention, tie rods are arranged inside or outside the supporting pillar in the region of the connection of the supporting pillar to the base for the purpose of imposing a pretensioning force.

In accordance with an embodiment, the flow power plant comprises at least one turbine and a hub with at least one rotor blade. In accordance with the invention, tie rods are arranged inside the rotor blade and especially in the region of the connection of the rotor blade to the hub inside or outside the rotor blade to impose a pretensioning force. Combinations of rotor blades provided with tie rods and supporting pillars provided with tie rods can be considered.

The tie rods are preferably pretensioned in the installed state of the supporting pillar or the rotor blade.

The tie rods only transmit tensile forces, but no pressure or bending forces. As a result, tensile forces occurring in the foundation structure are only introduced via the tie rods into the foundation or into the hub of the rotor. The remaining forces and torques, especially pressure and shearing forces, are transmitted to the foundation by the material of the supporting pillar surrounding the tie rods and that of the rotor blade blades to the hub. The foundation and supporting pillars can consist completely or partly of concrete or steel. The tie rods can preferably be made of steel, especially pre-stressing steel.

According to an embodiment, the tie rods can be present in form of fibres, cables, bars or tubes. In the case of fibres, they can be present in form of laid fabrics, knitwear, knitted fabrics or woven fabrics. Massive bars, e.g. with threads in the manner of screws, can be considered as rods.

The tensile modulus of the tie rods can be a multiple, especially 5 to 10 times, preferably 5 to 20 times, of the material of the supporting pillar or the rotor blades in which the tie rods are embedded.

The invention is explained by reference to embodiments shown in the drawings, wherein:

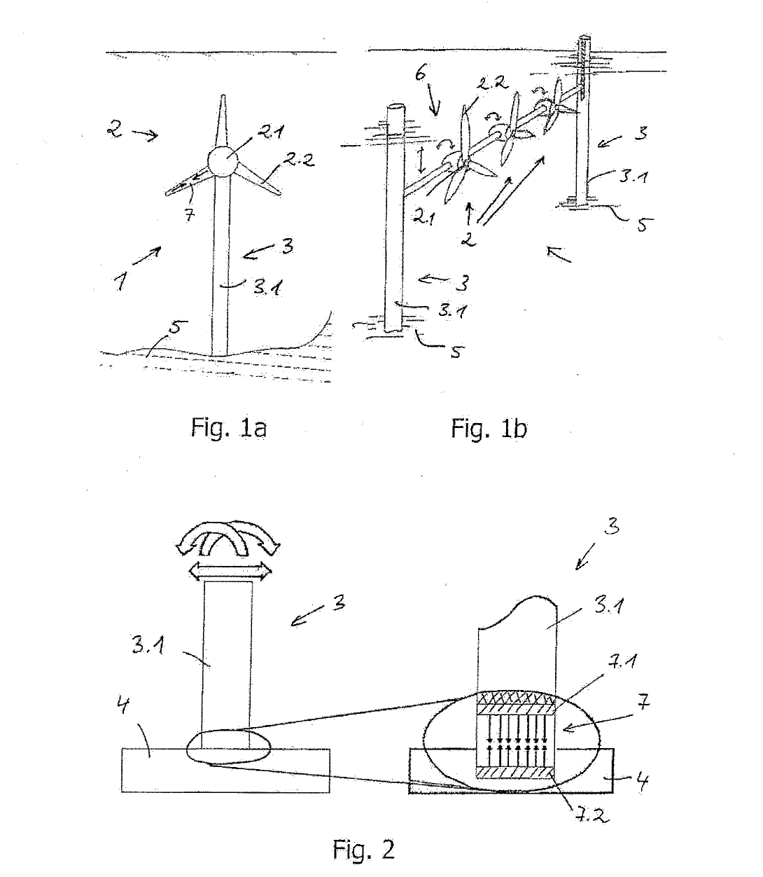

FIG. 1a shows a front view of marine current power plant;

FIG. 1b shows a further embodiment of an immersed underwater power plant;

FIG. 2 shows a preferred embodiment of the foundation structure of the flow power plant in accordance with the invention.

FIG. 1 a shows a flow power plant 1 in a front view in the direction of the main flow of the surrounding medium, which is water in this case. The flow power plant 1 can be part of a flow power plant farm, comprising a plurality of flow power plants arranged in and transversely to the direction of the main flow, which are not shown here.

The flow power plant 1 according to Figure la comprises a turbine 2, which is provided in this case in form of a rotor with a hub 2.1 and in the present case with three rotor blades 2.2. It is understood that more or fewer than three rotor blades 2.2 can be provided. The hub 2.1 and the rotor blades 2.2 are arranged in a torsion-proof manner with respect to each other. The turbine 2 can be connected to a drive train (not shown) in order to convert kinetic energy of the medium into rotational energy of the turbine 2. The hub 2.1 can be coupled for this purpose in the drive train to a generator (not shown) for driving the same. The turbine 2 is connected in the present case to a foundation structure 3. The latter comprises in the present case a single supporting pillar 3.1, which is connected to the bottom of the water body by a foundation (not shown). In the present case, the supporting pillar 3.1 is arranged cylindrically over its entire length. This is not mandatory however. The cross-sectional shape could deviate from the circular shape. Elliptical, oval or streamlined cross-sectional shapes can be considered in particular. The cross-section of the supporting pillar 3.1 can also taper in the direction away from the bottom 5 of the body of water towards the turbine 2.

FIG. 1b shows a further embodiment of a flow power plant in a spatial view. Three turbines 2 are provided in the present case, each comprising a hub 2.1 and three rotor blades 2.2. Each of the three turbines is held on a transverse supporting structure 6, which is arranged in the present case as a crossbeam. Other connections could be considered instead of the crossbeam, especially diagonally strutted connections or bracings in form of gratings or matrixes. The transverse supporting structure 6 is held in the present case at its two ends by a respective foundation structure 3, which also respectively comprises a supporting pillar 3.1. The foundation structure 3, turbines 2 and the transverse supporting structure 6 form the flow power plant 1 in the present case. As already explained with respect to FIG. 1a, a plurality of the flow power plants 1 as shown in FIG. 1b can be arranged in the main direction of flow of the medium adjacent to each other and/or behind one another. The turbines 2 can drive a generator (not shown) separately or jointly.

Each turbine 2 can also be pivotable with respect to the transverse supporting structure 6, which can also be provided independently of the remaining ones. The crossbeam 6 can also be displaceably arranged in an alternative manner or in addition along the longitudinal axis of the foundation structure, i.e. in the direction towards the water level or the bottom 5 of the water body.

FIG. 2 shows a potential embodiment of the foundation structure 3 in a highly simplified illustration, as can be used in FIGS. 1a and 1b. The supporting pillar 3.1 is shown in the left part of FIG. 2. It is inserted into a foundation 4, which is fixed to the ground 5 (FIGS. 1a and 1b) of the water body. As is indicated by the arrows, the reaction forces of the turbine 2 are transmitted to the foundation 4 via the foundation structure 3 as a result of the flow around said turbine by the medium. The forces may concern tensile, pressure, thrust, torsional and/or bending forces and the associated torques.

A critical point where the aforementioned forces and torques cause considerable tensions is the region of the transition of the supporting pillar 3.1 to the foundation 4. The tensions in the material of the supporting pillar 3.1 can exceed the maximum value for the expected operational lifespan of said pillar here.

In order to prevent this, tie rods 7 are introduced in accordance with the invention especially in the transitional region from the base of the supporting pillar 3.1 to the foundation 4. The tie rods 7 are shown symbolically in the enlarged right view of FIG. 2 in form of force arrows.

The tie rods are pretensioned in the present case between two anchor structures 7.1 and 7.2, which are arranged in this case as plates. Both anchor plates 7.1, 7.2 are opposite of each other in this case. The upper anchor plate 7.1 which is closer to the turbine 2 and situated above the foundation 4 is linked to the supporting pillar 3.1 or is cast into said pillar. The opposite bottom anchor plate 7.2 is introduced in the region of the foundation 4 and can also be connected to the base end of the supporting pillar 3.1 or it can also be cast into said pillar. The material of the supporting pillar 3.1 can also be provided between the anchor plates 7.1, 7.2. This is not mandatory however. The tie rods 7 are pretensioned between the two anchor plates 7.1 and 7.2. They extend in the present case with their longitudinal axes substantially parallel to the longitudinal axis of the supporting pillar 3 and thus perpendicularly or angularly to the rotational axis of the turbine 2 or the hub 2.1. The use of anchor plates is not mandatorily necessary for the present invention. Other means that can be used to apply a pretension to the tie rods 7 can also be considered.

The supporting pillar 3.1 and the foundation 4, which form the foundation structure 3, can also be produced in an integral fashion, e.g. by casting, so that the tie rods are embedded both in the supporting pillar 3.1 and also in the foundation 4.

The introduction of a pretension in accordance with the invention into the foundation structure considerably reduces the material tensions in the transitional region from the supporting pillar 3.1 to the foundation 4. The superposition of the pretension with the other operating loads leads to a reduced material tension in this region and thus increases the operational lifespan of the foundation structure.

The tie rods 7 can also be provided in the foundation 4 in an alternative or additional way, especially in its entire extension. The information provided above concerning the embodiments applies analogously.

It could also be considered in addition or alternatively to embed such tie rods 7 in the rotor blades 2.2 and/or in the hub 2.1 of the turbine 2. They could preferably extend parallel to the longitudinal axis of the rotor blades 2.2 and also be pretensioned. This is indicated in FIG. 1a symbolically by the two arrows on one of the rotor blades 2.2. The information provided above concerning the embodiments also applies analogously in this case. Combinations of the aforementioned embodiments can thus also be considered. In particular, the flow machines could comprise tie rods both in the rotor blades and also in the foundation structure and especially in the supporting pillars.

The invention can be applied to flow power plants which are completely immersed, and thus also to turbines. The invention can also be applied to offshore wind turbines which comprise a foundation situated on the ground of the sea, which foundation carries one or several pillars, and in which the turbines are situated above the water level.

### LIST OF REFERENCE NUMERALS

1 Flow power plant
2 Turbine
2.1 Hub
2.2 Rotor blade
3 Foundation structure
3.1 Supporting pillar
4 Foundation
5 Ground of the water body
6 Transverse supporting structure
7 Tie rod
7.1 Anchor plate
7.2 Anchor plate

1-6. (canceled)

7. A flow power plant comprising:
at least one turbine; and
a hub with at least one rotor blade;
wherein a plurality of tie rods for applying a pretensioning force are arranged inside or outside of the at least one rotor blade in the region of a connection of the at least one rotor blade to the hub.

8. The flow power plant according to claim 7, wherein the plurality of tie rods are pretensioned in a mounted state of the at least one rotor blade.

9. The flow power plant according to claim 7, wherein the plurality of tie rods are present in form of fibres, cables, bars or tubes.

10. The flow power plant according to claim 8, wherein the plurality of tie rods are present in form of fibres, cables, bars or tubes.
